(19) United States
(12) Patent Application Publication
(10) Pub. No.: US 2015/0124485 A1
(43) Pub. Date: May 7, 2015

(54) FIELD INSTRUMENT WITH DISPLAY DEVICE

(71) Applicant: KROHNE Messtechnik GmbH, Duisburg (DE)

(72) Inventors: Helmut Brockhaus, Oberhausen (DE); Ulrike Schwenger, Gelsenkirchen (DE)

(73) Assignee: KROHNE MESSTECHNIK GMBH, Duisburg (DE)

(21) Appl. No.: 14/521,836

(22) Filed: Oct. 23, 2014

(30) Foreign Application Priority Data
Oct. 24, 2013 (DE) 10 2013 017 563.1

(51) Int. Cl. F21V 8/00; G08B 5/36

(52) U.S. Cl. CPC G02B 6/0068; G02B 6/0075; G08B 5/36
USPC 362/613; 362/97.1

(57) ABSTRACT

A field instrument (1) with a display device (4) that allows a flexibility of display that is as great as possible for a hardware structure that is as small as possible by the display device (4) having a light guide device (8) and a luminous unit (12, 14) which emits light in a direction toward the light guide device (8).

### BACKGROUND OF THE INVENTION

1. Field of the Invention

The invention relates to a field instrument with at least one display device. The field instrument is, for example, a measuring instrument for determining at least one measured variable (for example, fill level, flow rate, pH or temperature) of a medium (for example, a liquid, a bulk material, a gas or a mixture) or of a process. Alternatively, the field instrument is an actuator for influencing a process or a process variable.

2. Description of Related Art

In process automation, it is largely provided in the prior art that field instruments are connected via so-called field busses to control rooms and are controlled by them or transmit their data to them. But in part, field instruments with display units, so-called displays, are used for direct output of data or information or for direct dialogue between a user and the field instrument. These displays are thus also parts of so-called “human-machine interfaces”.

These on-site displays can often be difficult to read depending on the prevailing ambient conditions. Furthermore, due to the diversity of the displayed information, it can be involved for a user to effectively and promptly grasp important information.

In U.S. Pat. No. 4,734,619 a display is described in which, for improved legibility, a background color and the color of the displaying elements are chosen and set separately. The actual representation takes place via a seven-segment display, as a result of which the potential information which can be displayed is limited. There are three different light emitting diodes (LEDs) at a time for each segment and for the background.

A display whose entire background undergoes a change in color in the case in which a measured value is outside a defined range is described in European Patent Application EP 2 546 823 A1.

### SUMMARY OF THE INVENTION

Therefore, a primary object of the present invention is to devise a field instrument whose display device allows flexibility of display that is as great as possible for a hardware structure that is as small as possible.

The field instrument in accordance with the invention in which the aforementioned object is achieved is, first of all, essentially wherein the display device has at least one light guide device, that there is at least one luminous unit and that the light guide device and the at least one luminous unit are made and arranged relative to one another such that the luminous unit emits light in the direction of the light guide device. The luminous unit is in particular also assigned to the display device.

Optical fibers are generally transparent components which guide light. The light is guided by reflection on the interface of the optical fiber either by total reflection based on a smaller index of refraction of the medium surrounding the optical fiber or by metal-coating of the interface.

Other optical fibers known in the prior art are planar optical waveguide structures (PLWL) which are made at least partially of plastic, such as, for example, PMMA (polymethylmethacrylate, acrylic or plexiglass) or polycarbonate.

The light guide device of the display device of the field instrument in accordance with the invention is preferably made planar so that in particular a larger area results for emission of light. The large-area emission increases the legibility of the display and the signal character. Furthermore, for example, special effects can also be caused over a larger area by the interaction of the different light sources or by adding structures to the light guide device.

In the field instrument in accordance with the invention, a light guide device is used in the display device which routes the light of a luminous unit.

In one version, at least one luminous unit is used as a fault state illumination and emits light of a selectable signal color.

A fault state is for example, that a fault occurs in the field instrument so that, for example, a function of the device cannot be executed.

If the field instrument is especially a sensor, in one configuration, a fault state occurs if a determined measured value for a process variable is outside a given interval. Alternatively, a fault state can occur when a current measured value is not plausible in relation to previous measured values, for example, has an overly large deviation.

The fault state in one configuration is recognized based on a calibration of the field instrument with values which have been determined by it itself, therefore, it is a purely internal calibration of the values which have been measured or determined by the field instrument itself.

In another configuration, a fault state occurs when it is recognized that data communication, for example, via a field bus to which the field instrument is connected, is not functioning properly. For this reason, for example, an interface of the field instrument and the data communication via it are monitored.

If a fault state occurs, the at least one luminous unit—for example, a light emitting diode—emits light of a definable signal color. For example, the signal color is the color red.

In one configuration, in particular, the at least one luminous unit and the light guide device are made and matched to one another such that only a limited section of the light guide device is lit or fully illuminated or trans-illuminated by the light of the luminous unit.

In one alternative configuration, the light guide device is essentially completely illuminated by the luminous unit which is used as fault state illumination.

The light guide device, in one configuration, has at least one emission surface via which the light which has been routed into it is emitted.

With respect to the luminous unit which is being used as fault state illumination, it is provided in one configuration that it irradiates at least the light guide device in a direction toward the emission surface—optionally, limited to a certain region.

The luminous unit is therefore aligned in the direction toward the emission surface, and thus, irradiates the light guide device. In one configuration, this results in that the light of the luminous unit which is being used as the fault state illumination is not distributed onto a larger region of the emission surface, but remains in a smaller, limited section.

In one configuration, there is at least one at least partially transflective display unit. The display unit is made as a liquid crystal display (LCD) in one configuration.

The transflective (or also transreflective) property of the display unit means that it is semitransparent so that it can work reflectively and transmissively. That is, not only is light reflected for the display of contents, but light is also allowed through.

The transflective property is used to implement background lighting of the display via the display unit by way of the light guide device.

Therefore, in one configuration, the light guide device and the display unit are made and arranged relative to one another such that the emission surface of the light guide device is facing the display unit. In this configuration, the display unit is used to display the actual information and background lighting is made available via the light guide device such that, via the display of the data and the background lighting, legibility is as good as possible and also preferably a high signal character of the information displayed on the display device are produced.

The recognition of the presence of fault states by a user is promoted, in particular, by at least the luminous unit which is being used as fault state illumination irradiating at least the light guide device in the direction toward the emission surface and the display unit. The light in the signal color is therefore preferably routed such that it can be optimally recognized by the user.

The indicated luminous unit which is used as fault state illumination shines through the display unit with its signal color and in doing so illuminates a special section of the display unit in one configuration. This section of the display unit constitutes, for example, a symbol which is assigned to the corresponding fault state. The gaze of the viewer or user is guided to the corresponding region and the information displayed there in a dedicated manner by the light of the signal color.

Therefore, preferably, in one configuration, the luminous unit which is being used as fault state illumination is located relative to a region of the display unit which has a symbol which is associated with a fault state or displays it in a dedicated manner for the respective fault state.

In one configuration, an illustration or explanation is output or displayed by the display unit in the case of a fault state in addition to signaling of the state. A fault is generally an extraordinary state so that a fault constitutes a deviation from the normal case. The illustration here is a description of the fault state, or for example, the measured value which is outside of a given region, or for example, an input; this can be undertaken as a reaction to the fault state.

In one alternative configuration, corresponding explanations are attached to the field instrument.

In one configuration, there is at least one control device for triggering the luminous unit which is being used as fault state illumination.

The control device is especially made for detecting at least one fault state of the field instrument and/or of the vicinity of the field instrument, and in the case that there is a fault state, actuates the luminous unit which is being used as fault state illumination such that the luminous unit which is being used as fault state illumination emits light of a selectable signal color.

In another configuration, the control device also triggers the display unit in the case of a fault such that it produces a corresponding display or optionally changes a display.

The control device in one configuration comprises at least one microprocessor which monitors the processes in the field instrument or in the region of the periphery of the field instrument and evaluates them at least with respect to the presence of a fault. If such a fault is present, the control device activates at least the luminous unit which is being used as fault state illumination so that it emits light in the signal color.

In another configuration, the control device also triggers the display unit such that, in the interaction between the display unit and the at least one luminous unit, signaling of a fault state arises. Thus, the control device, for example, causes the display unit to display a character or symbol which is assigned to the fault state.

In one configuration, optionally, in interworking with other luminous units, interference phenomena or coherence phenomena are used so that, for example, three-dimensional display effects arise.

In one configuration, the display unit behaves at least partially passively in case of a fault with reference to signaling, since there are already corresponding characters or symbols on or in the display unit which are illuminated by the light in the signal color of the luminous unit which is being used as fault state illumination.

In one alternative configuration, the display unit acts actively by its displaying data or information in a dedicated manner depending on the respective fault state.

In one alternative or supplementary configuration to the preceding, in one configuration, it is provided that at least one luminous unit is used as background lighting and radiates light directly into a lateral surface of the light guide device. The actual light of the background lighting is emitted directly into a face side, i.e., preferably without further optical elements or effects which divert the light.

In one configuration, the light of the background lighting is therefore produced and radiated directly by the corresponding luminous unit such that the direction of propagation of the light runs into one plane parallel to the emission surface of the light guide device.

The lateral or face surface of the light guide device in this configuration is radiated directly with the light of a luminous unit and is routed in it in order to be emitted preferably via the emission surface of the light guide device. Preferably, the light guide device is used in one configuration as background lighting for the transflective display unit which has already been described above.

In one configuration, the light guide device is made essentially wedge-shaped.

In a further configuration, the luminous unit which is used for background lighting is located on the face side of the wedge-shaped light guide device with the larger area, therefore on the side of the widening of the wedge.

In one configuration, the light guide device has a coating which reflects light. The coating in one configuration is located on a side which is opposite the emission surface. The coating can also be partially formed in a roughening.

The coating is made essentially homogeneous in one configuration.

In one alternative configuration, the coating has structures or different regions which, in interaction with the luminous units, make it possible to achieve different optical effects.

The coating of the light guide device is used for scattering of the light which has been guided in the light guide device so that, in particular, the emission surface is fully illuminated over a large area when a luminous unit which serves as background lighting is being used.

In another configuration, there are several luminous units which are used as background lighting.

In one configuration, there are several luminous units which are used for fault state illumination.

In one configuration, the fault state illumination-luminous units are placed at different locations so that they also fully illuminate different regions of the display unit.

In one alternative configuration, the aforementioned luminous units essentially completely illuminate the same region of the display unit.

In one configuration, the luminous units which are used in the display device emit light of essentially the same color and in another configuration of a different color.

In one configuration, the respectively emitted light of the individual luminous units is matched to one another such that interference effects result for a superposition.

The colors of the emitted light in another configuration are chosen and matched to one another such that additive or subtractive color effects arise in the regions in which the light is superimposed.

Furthermore, in one configuration, it is provided that the luminous units are made for fault state illumination and for background lighting and are suitably triggered such that further effects arise by their interaction. In one configuration, this is supplemented by the regions of the display unit, through which the light of at least one luminous unit which is being used as fault state illumination is incident, displaying data, information or symbols which correspond to the respective fault states.

In one configuration, the transparency for the light of the luminous units is changed by suitable manipulation of the display unit and of the light guide device, for example, by application of voltages.

In another configuration, in addition, there is at least one sensor which detects the brightness ratios in the vicinity of the field instrument or of the display device so that the control device sets the brightness or the contrast of the display via the display unit based on the measurement data of the sensor.

Furthermore, in one configuration, there is at least one photovoltaic cell which converts part of the light of the luminous units into an electrical current.

In one configuration, the field instrument is made as an actuator for controlling or adjusting a process variable or a process.

In one alternative configuration, the field instrument is a sensor, for which there is at least one measuring device for determining at least one measured variable. The measured variable is, for example, the fill level, the flow rate, or the pH of a medium.

To connect the field instrument to a field bus via which data are communicated, for example, according to one standard protocol which is known in the prior art, in one configuration, there is at least one interface for sending and/or receiving data.

In one configuration, the control unit monitors the field bus via the interface, and in this way, detects whether there is a fault state.

In another configuration, the interface is a so-called service interface, as is conventional in many field instruments of the prior art.

In one configuration, the display device is provided with at least one cover with at least one viewing port. Here, the cover is used to protect the display device from ambient influences. Through the viewing port, it is possible to look at the display unit and/or at least the effects of the light guide device.

In one configuration, in addition, there is an input unit, for example, in the form of a few keys, via which an interaction between a user and the field instrument at the installation site of the field instrument is possible.

In one configuration, the especially transflective display unit is located between the light guide device and the viewing port.

In one configuration, at least one luminous unit is made such that it emits light of a variably adjustable color. The luminous unit makes it possible to produce a different color depending on what is to be signaled or which background color there is.

In one configuration, at least one luminous unit is a light emitting diode.

In particular, at this point, there are a host of possibilities for embodying and developing the field instrument in accordance with the invention. In this regard, reference is made to the following description of exemplary embodiments in conjunction with the drawings.

### BRIEF DESCRIPTION OF THE DRAWINGS

FIG. 1 shows a schematic of a field instrument in a section and

FIG. 2 is an exploded view of the field instrument.

### DETAILED DESCRIPTION OF THE INVENTION

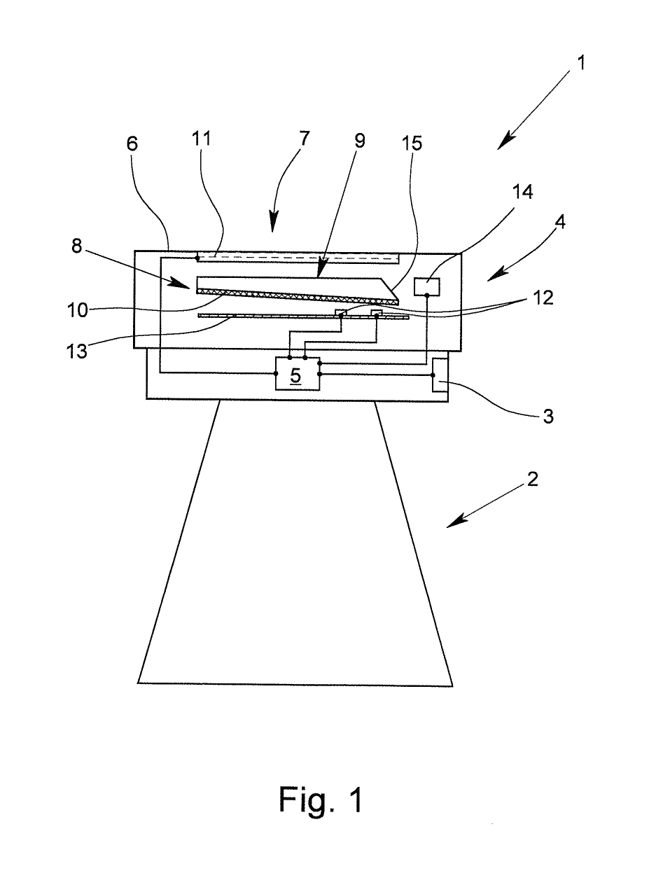

FIG. 1 schematically shows a section through a field instrument 1. The field instrument 1 is made as a sensor and has a measuring device 2 whose antenna is used to send and receive microwave signals for determining the level of a medium (not shown) according to the radar principle.

There is an interface 3 for communication of the measurement data, for example, via a field bus (not shown here) with a control room (likewise not shown).

Furthermore, there is a display device 4 for a user which is used for displaying the measured values or for inputting of operator parameters.

Measurement with the measuring device 2, data output via the interface 3 and also the display of the measured values via the display device 4 are carried out via a control device 5. The latter is especially at least one microprocessor which is connected to the corresponding components of the field instrument 1.

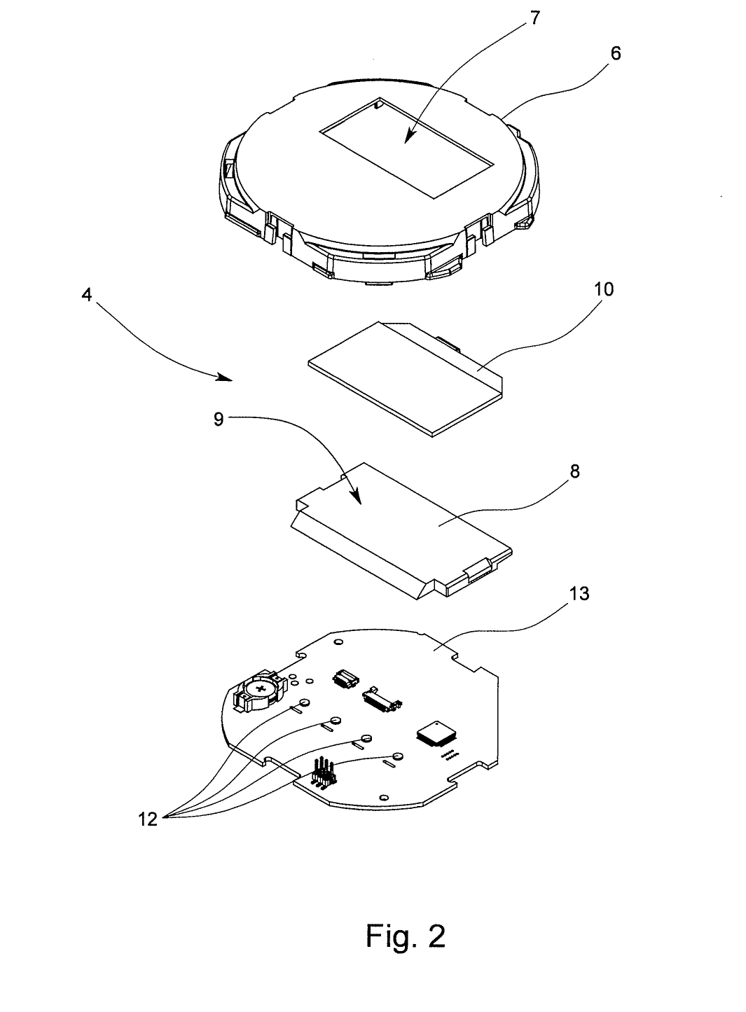

The display device 4 has a cover 6 which is made correspondingly durable against process or ambient conditions, and which here especially has a viewing port 7. Under the viewing port 7, in the interior of the display device 4, there are the components which are used for the actual display. In particular, there is a light guide device 8 which has an essentially rectangular emission surface 9 facing in the direction of the viewing port 7 (see, FIG. 2) and which is otherwise made wedge-shaped. On the other side, which faces away from the viewing port 7, there is a coating 10 which diffusely reflects essentially light which is being radiated into the light guide device 8, and thus produces a type of background lighting. In one configuration, the light guide device 8 is formed especially at least partially or completely of a corresponding plastic.

In the drawings, above the light guide device 8, and thus nearer in the direction of the viewing port 7, there is a display unit 11 which is here especially a liquid crystal display (LCD) which is transflective and which therefore allows light to shine through. The light which is shining through is especially the background light of the light guide device 8.

The display unit 11 is triggered by the control device 5 so that the actual display of the measured values, of parameter values, of text, etc. is accomplished via the display unit 11.

Underneath the light guide device 8, there are luminous units 12, here for example, in the form of light emitting diodes, which emit colored light, for example, red or yellow, and in doing so, radiate directly through the light guide device 8, and in this way, illuminate regions of the display unit 11 in a controlled manner with a special signal color.

In another configuration which is not shown here, light is emitted in the infrared range so that a temperature effect arises.

The luminous units 12 are mounted on a printed-circuit board 13.

The luminous units 12 which are thus used for signaling of fault state are activated by the control device 5.

To perform its functions, the control device 5 has the capability to detect in particular faults in the field instrument 1 itself. A fault is quite generally a state which differs from normal operation. This goes along with the control device 5 having a selectable definition of normal.

A fault is, for example, an operating fault in the field instrument 1, a fault in a measurement with the measuring device 2 or a fault in the vicinity of the field instrument 1. It is especially measured values which lie outside a definable interval, or for example, problems with data communication via a field bus, to which the field instrument 1 is connected via the interface 3. The number and type of fault states can also be tailored especially to the application of the field instrument 1.

If such a fault is detected by the control device 5, it turns on the corresponding luminous unit 12, and thus, allows, for example, a symbol to appear on the display unit 11 with a correspondingly high contrast.

For this purpose, the display unit 11 has especially fault symbols which also correspond preferably to the existing standards and which flash by the particular fault state illumination by the corresponding luminous unit 12.

In one special version, a fault state is emphasized by the joint triggering of the luminous units 12 of the fault state illumination and of the luminous units 14 of the background lighting by effects arising by the mixing of different colors.

This type of illumination which fills the display unit 11 in particular only partially for the case of a fault differs from the normal background lighting as is carried out by the luminous unit 14 which is located laterally relative to the side surface 15 of the light guide device 8. The presence of the fault state becomes more easily and more promptly recognizable for the user by the difference which has been produced.

The side surface 15 of the light guide device 8 is, moreover, also the larger side of the wedge which is formed by the light guide device 8.

The background lighting-luminous unit 14 radiates laterally and especially directly into the light guide device 8 and scattering takes place diffusely there on the coating 10 so that the background lighting for the display unit 11 occurs.

FIG. 2 shows some components of a display device 4 of a field instrument in an exploded view.

On the circuit board 13, there are a total of four luminous units 12, each of which are used for one special fault state illumination and irradiate only a partial region of the display unit 11 and of the light guide device 8.

Above the four luminous units 12 is the light guide device 8 which provides background lighting by a corresponding luminous unit 14 which radiates on a face side.

The background lighting appears through the display unit 11 which is made at least partially transflective and which is used for actual display of the data or information via the display device 4.

The components are encompassed by a cover 6 which is made correspondingly resistant and which has a viewing port 7. There is preferably another covering film (not shown here) above or underneath the viewing port 7.

What is claimed is:

1. A field instrument, comprising:
at least one display device,
at least one light guide device, and
at least one luminous unit
wherein the at least one light guide device and the at least one luminous unit are constructed and arranged relative to one another such that the luminous unit emits light toward the light guide device for illuminating at least a portion of the at least one display device.

2. The field instrument in accordance with claim 1, wherein the at least one luminous unit emits light of a selectable signal color for fault state illumination.

3. The field instrument in accordance with claim 1, wherein the at least one light guide device has at least one emission surface.

4. The field instrument in accordance with claim 3, wherein the at least one luminous unit irradiates the at least one light guide device in a direction toward the emission surface.

5. The field instrument in accordance with claim 1, wherein the at least one display device comprises at least one partially transflective display unit.

6. The field instrument in accordance with claim 3, wherein the at least one display device comprises at least one partially transflective display unit and wherein the at least one light guide device and the at least one display unit are constructed and arranged relative to one another such that the emission surface of the light guide device faces the display unit.

7. The field instrument in accordance with claims 6, wherein at least the at least one luminous unit irradiates at least the at least one light guide device in a direction toward the emission surface and the display unit.

8. The field instrument in accordance with claim 2, further comprising at least one control device for triggering the luminous unit, wherein the control device is adapted for detecting at least one of at least one fault state of the field instrument and in the vicinity of the field instrument and wherein the control device is adapted to actuate the luminous unit for a fault state illumination when a fault state is detected.

9. The field instrument in accordance with claim 1, wherein at least one other luminous unit radiates light directly into a lateral surface of the light guide device to produce background lighting.

10. The field instrument in accordance with claim 3, wherein the at least one light guide device has a light-reflecting coating on a side which is opposite the emission surface.
